(19) United States
(12) Patent Application Publication
(10) Pub. No.: US 2007/0263258 A1
(43) Pub. Date: Nov. 15, 2007

(54) Image transmitting apparatus, image receiving apparatus, and image transmitting and receiving apparatus and system

(75) Inventors: Kiyotaka Tsuchibuchi, Ebina-shi (JP); Toshiyuki Yamada, Ebina-shi (JP); Junichi Shimizu, Ebina-shi (JP); Masato Saito, Ebina-shi (JP); Hiroshi Niina, Ebina-shi (JP); Zhenrui Zhang, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/633,036

(22) Filed: Dec. 4, 2006

(30) Foreign Application Priority Data
May 10, 2006 (JP) 2006-131089
May 16, 2006 (JP) 2006-136110

(51) Int. Cl. G06F 3/12

(52) U.S. Cl. 358/400; 358/1.15

(57) ABSTRACT

An image transmitting apparatus includes an image reading unit that reads image data, a decision unit that decides whether recipient address information included in the image data read by the image reading unit matches recipient address information specified as a destination, a processing unit that processes the recipient address information included in the image data read by the image reading unit, and a transmitting unit that transmits the image data in which the recipient address information has been processed by the processing unit to the specified destination, depending on a result of the decision made by the decision unit.

### BACKGROUND

1. Technical Field

The present invention relates to an image transmitting apparatus that transmits image data, an image receiving apparatus that receives image data transmitted from the image transmitting apparatus, an image transmitting and receiving apparatus such as a facsimile apparatus for transmitting and receiving image data, and an image transmitting and receiving system.

2. Related Art

An image transmitting and receiving apparatus such as facsimile apparatus is used to transmit image data to a remote site. In such image transmitting and receiving apparatus, entering a wrong number as a recipient address gives rise to a problem such as information leakage. In view hereof, a facsimile apparatus provided with a function for preventing misdirected transmission of a facsimile paper image is proposed.

For the purposes of correspondence sales, questionnaires, and the like, recently, facsimile is utilized such that a form such as an order form is faxed from a facsimile apparatus and a recipient of the form fills in necessary information on the faxed form and sends back it by facsimile. Also, a facsimile paper may be circulated among multiple parties by way of image transmitting and receiving apparatus.

However, in the above facsimile apparatus of related art, the following problem is posed: in the case of filling in information on a faxed form and sending back it directly to the sender or in the case of forwarding a faxed facsimile paper to another recipient, the misdirected transmission preventing function is activated, thus resulting in a transmission error; consequently, the misdirected transmission preventing function cannot be used.

### SUMMARY

According to an aspect of the invention, there is provided an image transmitting apparatus including:

an image reading unit that reads image data;

a decision unit that decides whether recipient address information included in the image data read by the image reading unit matches recipient address information specified as a destination;

a processing unit that processes the recipient address information included in the image data read by the image reading unit; and

a transmitting unit that transmits the image data in which the recipient address information has been processed by the processing unit to the specified destination, depending on a result of the decision made by the decision unit.

### BRIEF DESCRIPTION OF THE DRAWINGS

Exemplary embodiments of the present invention will be described in detail based on the following figures, wherein:

FIG. 1 is a diagram to explain the operation of an image transmitting and receiving system that prevents misdirected transmission based on the recipient address information imprinted on a facsimile paper to be faxed;

FIG. 2 illustrates an example of a facsimile paper to be faxed imprinted with a two-dimensional code in which recipient address information has been encoded;

FIG. 3 illustrates a system structure including an image transmitting and receiving apparatus 10 of a first exemplary embodiment of the present invention;

FIG. 4 is a block diagram showing a hardware configuration of the image transmitting and receiving apparatus 10 of the first exemplary embodiment of the present invention;

FIG. 5 is a block diagram showing an organization of functions of the image transmitting and receiving apparatus 10 of the first exemplary embodiment of the present invention;

FIG. 6 is a flowchart illustrating the operation of the image transmitting and receiving apparatus 10 of the first exemplary embodiment of the present invention;

FIG. 7 is a diagram to explain the operation of the image transmitting and receiving apparatuses 10, 20 of the first exemplary embodiment of the present invention;

FIG. 8 is a diagram to explain the operation of image transmitting and receiving apparatuses 10a, 20a, 30a of a second exemplary embodiment of the present invention;

FIG. 9 is a block diagram showing an organization of functions of an image transmitting and receiving apparatus 10b of a third exemplary embodiment of the present invention;

FIG. 10 illustrates an example of a transmission sequence list;

FIG. 11 is a flowchart illustrating the operation of the image transmitting and receiving apparatus 10b of the third exemplary embodiment of the present invention; and

FIG. 12 is a diagram to explain the operation of the image transmitting and receiving system of the third exemplary embodiment of the present invention.

### DETAILED DESCRIPTION

### [Background]

To help understanding of the present invention, its background and overview are described.

As noted above, there has been proposed an image transmitting and receiving apparatus adapted to extract the recipient address from a facsimile paper to be faxed, decides whether the recipient address matches the entered recipient address, and judges whether to enable its transmission in order to prevent misdirected facsimile transmission.

The following description assumes the use of an image transmitting and receiving system wherein the recipient address information as the destination is encoded and imprinted on the facsimile paper to be faxed in order to prevent misdirected facsimile transmission.

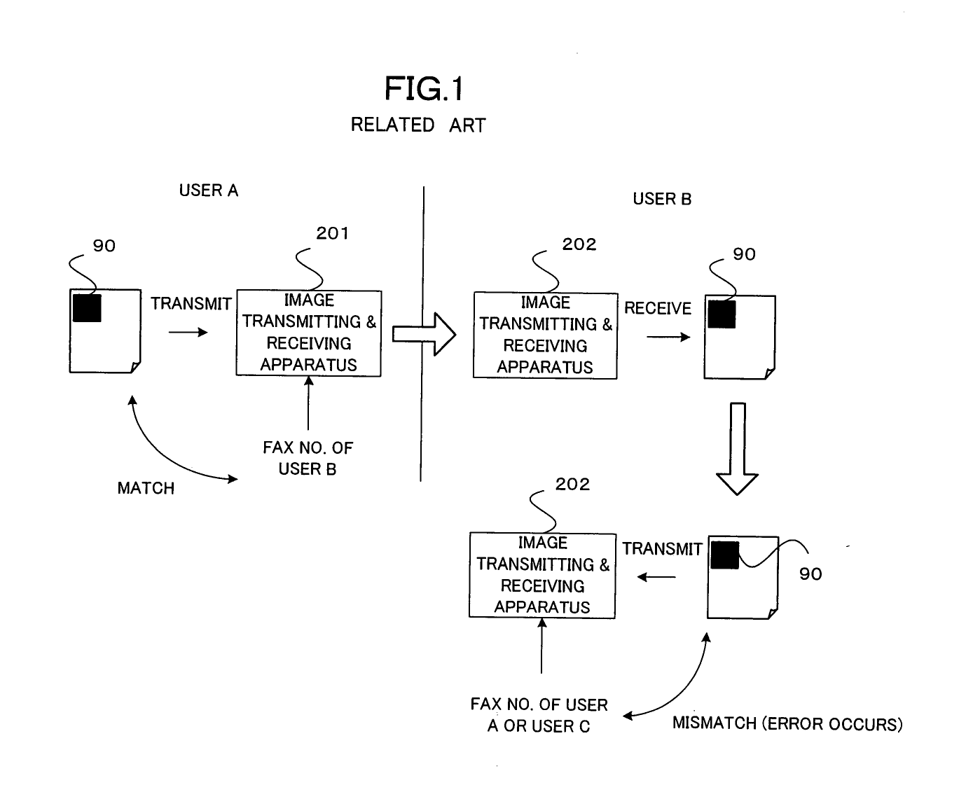

The operation of the image transmitting and receiving system that prevents misdirected transmission based on the recipient address information imprinted on the facsimile paper to be faxed is described with reference to FIG. 1.

In the image transmitting and receiving system shown in FIG. 1, facsimile transmission is performed between an image transmitting and receiving apparatus 201 of user A and an image transmitting and receiving apparatus 202 of user B. After a facsimile transmission from the image transmitting and receiving apparatus 201 of user A to the image transmitting and receiving apparatus 202 of user B, a facsimile transmission from the image transmitting and receiving apparatus 202 of user B to an image transmitting and receiving apparatus of user C further takes place.

When user A tries to transmit a facsimile paper to user B, the facsimile paper imprinted with the fax number of user B as the recipient address information is used. In FIG. 1, it is assumed that a two-dimensional code 90 in which the fax number of user B has been encoded is imprinted as the recipient address information on the facsimile paper to be transmitted by user A.

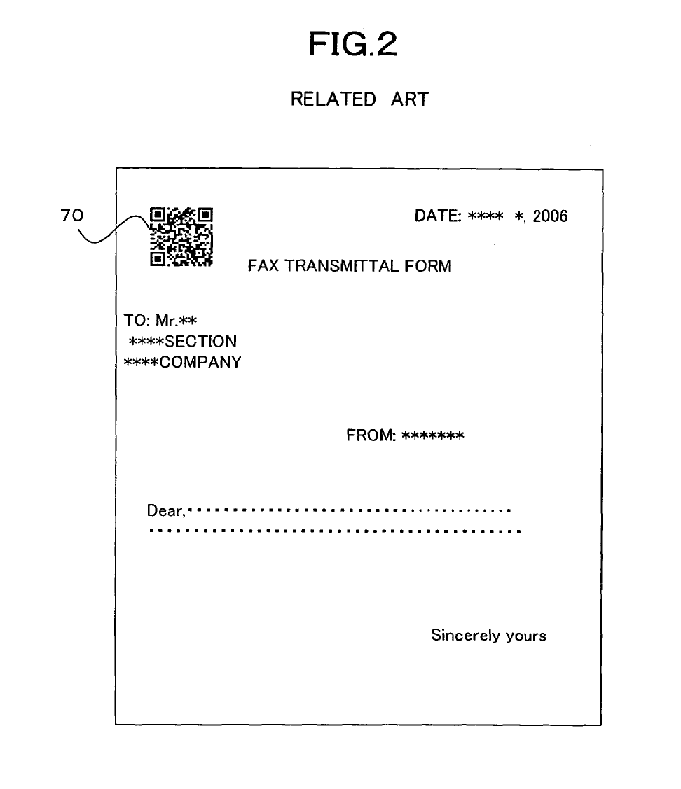

An example of such a paper to be faxed, imprinted with encoded recipient address information, is shown in FIG. 2. In the example shown in FIG. 2, a QR (QuickResponse) code is shown as an example of a two-dimensional code 70.

In the system shown in FIG. 1, the image transmitting and receiving apparatus 201 of user A executes the transmission to the image transmitting and receiving apparatus 202 of user B only if the entered fax number matches the recipient address information obtained by decoding the two-dimensional code 90. Therefore, even if user A enters a wrong fax number of user B, misdirected transmission is prevented.

However, according to such system, in the case when a facsimile paper of a given form such as an application form or an order form is faxed to a recipient and the recipient fills in data on the form and sends back it to the sender, the following trouble occurs.

Encoded recipient address information, which has been used when transmitting the form paper, is embedded into the faxed form paper. However, after the recipient fills in information on this form paper, when the recipient tries to send back or forward the form paper, the recipient address information which has already been embedded in the facsimile paper is the recipient's own fax number. This results in a transmission error and the form paper cannot be transmitted to another image transmitting and receiving apparatus. As a result, the recipient's image transmitting and receiving apparatus that received the form paper cannot use the misdirected transmission preventing function.

In such case, however, the misdirected transmission preventing function cannot be used for the form paper filled with data, despite that higher secrecy is required for transmission of the form paper filled with data than for transmission of a blank form paper.

In the example shown in FIG. 1, the form paper imprinted with the two-dimensional code 90 in which the fax number of user B has been encoded is assumed to be transmitted from the image transmitting and receiving apparatus 201 of user A to the image transmitting and receiving apparatus 202 of user B. After user B who received this form paper fills in information on the form paper, when user B tries to send back the form paper to the image transmitting and receiving apparatus 201 of user A, an error that disables the transmission of the form paper occurs in the image transmitting and receiving apparatus 202, because the two-dimensional code 90 as the encoded fax number of user B has already been imprinted on the form paper.

According to such system, when user B who received the page faxed from user A tries to forward the same received page to user C, the following trouble occurs.

When user B who received the page faxed from the image transmitting and receiving apparatus 201 of user A tries to forward the same received page to the image transmitting and receiving apparatus of user C, the entered fax number of user C does not match the fax number of user B obtained from the two-dimensional code 90. As a result, an error that disables the transmission of the page to be faxed to user C occurs in the image transmitting and receiving apparatus 202.

For the reasons described above, the misdirected transmission preventing function cannot be used when sending back a faxed page or forwarding a faxed page to another recipient in such image transmitting and receiving system.

### EXEMPLARY EMBODIMENTS

Next, exemplary embodiments of the present invention are now be described in detail with reference to the drawings.

### First Exemplary Embodiment

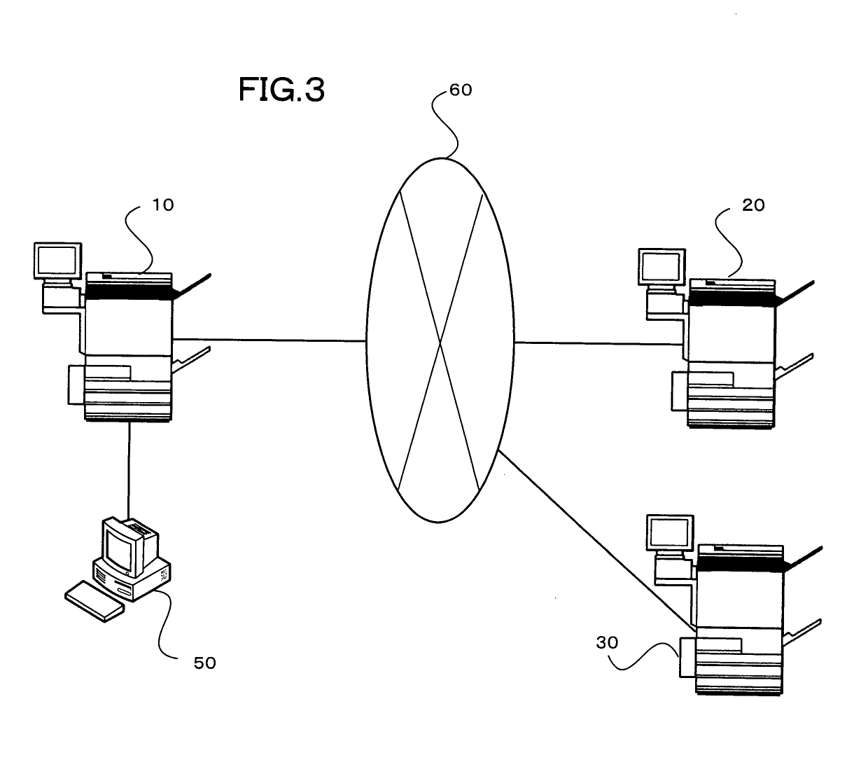

FIG. 3 illustrates an image transmitting and receiving system including image transmitting and receiving apparatuses 10, 20 of a first exemplary embodiment of the present invention.

As shown in FIG. 3, this image transmitting and receiving system is made up of the image transmitting and receiving apparatuses 10, 20 and a terminal device 50 such as a personal computer. The image transmitting and receiving apparatus 10 and the image transmitting and receiving apparatus 20 are connected by a communications network 60 such as a public network or the Internet. The terminal device 50 is connected to the image transmitting and receiving apparatus 10 and transfers image data to be faxed or image data to be printed to the image transmitting and receiving apparatus 10.

The image transmitting and receiving apparatus 10 transmits image data of a facsimile paper to be faxed, read by an image reader such as a scanner, or image data input from the terminal device 50 to the image transmitting and receiving apparatus 20 via the communications network 60.

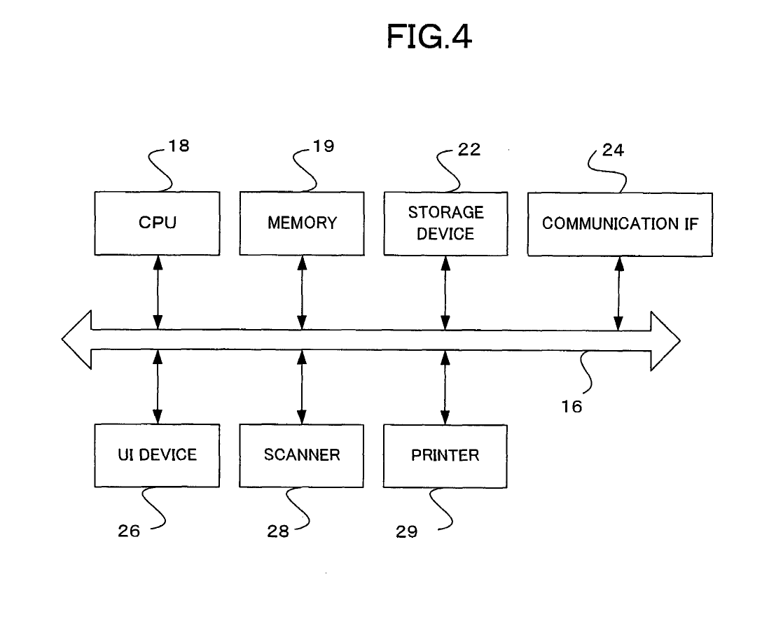

Next, a hardware configuration of the image transmitting and receiving apparatus 10 of the present exemplary embodiment is shown in FIG. 4.

As shown in FIG. 4, the image transmitting and receiving apparatus 10 includes a CPU 18, a memory 19, a storage device 22 such as a hard disk drive (HDD), a communication interface (IF) 24 responsible for transmitting and receiving data to/from an external computer or the like, a user interface (UI) device 26 including a touch panel or liquid crystal display and a keyboard, a scanner 28, and a printer 29. These components are interconnected via a control bus 16.

The CPU 18 performs predetermined processing tasks based on a program for transmitting and receiving images stored in the memory 19 or the storage device 22 and controls the operation of the image transmitting and receiving apparatus 10.

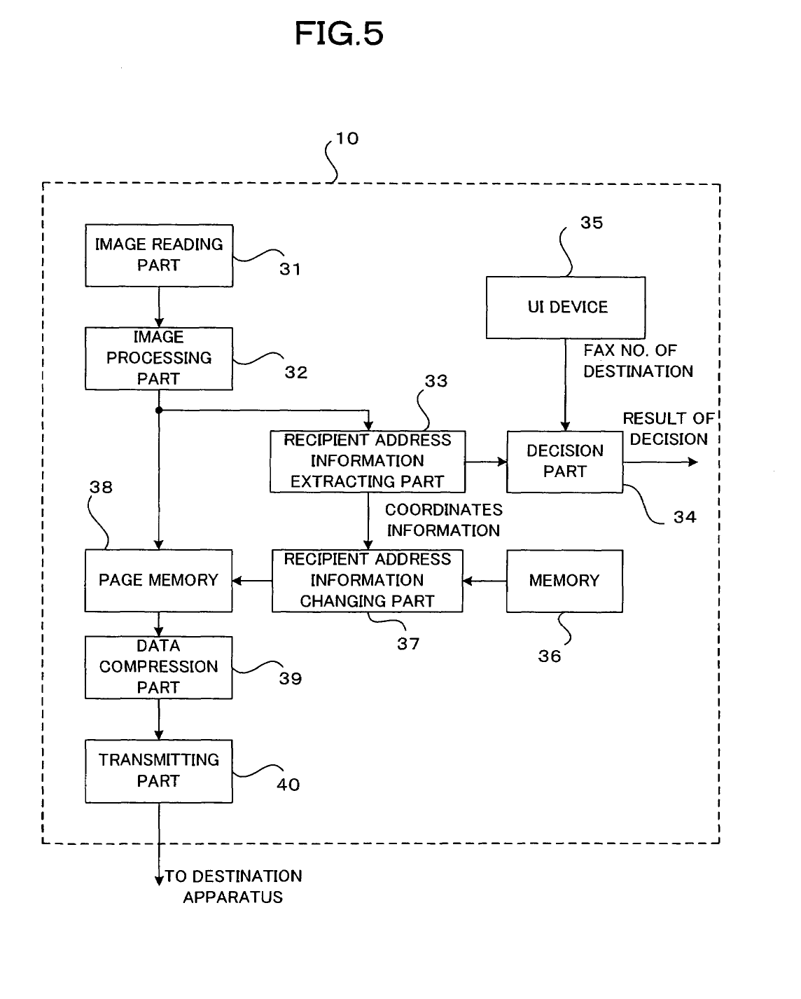

FIG. 5 is a block diagram showing an organization of functions of the image transmitting and receiving apparatus 10, which are realized by executing the above-mentioned program for transmitting and receiving images.

As shown in FIG. 5, the image transmitting and receiving apparatus 10 of the present exemplary embodiment includes an image reading part 31, an image processing part 32, a recipient address information extracting part 33, a decision part 34, a user interface (UI) device 35, a memory 36, a recipient address information changing part 37, a page memory 38, a data compressing part 39, and a transmitting part 40.

The image reading part 31 reads image data of a facsimile paper to be faxed. The image processing part 32 performs image processing such as filtering, binarizing, etc. on image data read by the image reading part 31. The page memory 38 stores image data processed by the image processing part 32 as the image data to be transmitted to a destination apparatus.

The recipient address information extracting part 33 detects recipient address information included in the image data processed by the image processing part 32 and extracts the recipient address information by decoding. Also, the recipient address information extracting part 33 indicates the coordinates information for the image of the extracted recipient address information to the recipient address information changing part 37.

The decision part 34 decides whether the fax number of the destination specified by the user via the UI device 35 matches the recipient address information extracted by the recipient address information extracting part 33.

The user interface (UI) device 35 functions as an input destination specifying unit by entering the fax number of the destination.

In the memory 36, bitmap data in which the apparatus' own fax number is encoded into a two-dimensional code is stored.

The recipient address information changing part 37 changes the recipient address information included in the image data that is going to be transmitted, stored in the page memory 38, to the apparatus' own address information stored in the memory 36, based on the coordinates information indicated from the recipient address information extracting part 33.

In particular, the recipient address information changing part 37 changes the recipient address information by overwriting an image of new address information over the image of the old recipient address information included in the image data. If the image of the recipient address information in the image data is larger than the image of the new address information to replace the former, the recipient address information changing part 37 performs the overwrite after adjusting the size of the image of the address information by adding margins to the image of the new address information.

The data compressing part 39 performs compression processing on the image data in which the recipient address information stored in the page memory 38 has been changed to the new address information.

The transmitting part 40 transmits the data compressed by the data compressing part 39 to the specified destination apparatus, depending on the result of the decision made by the decision part 34. In particular, the transmitting part 40 does not transmit the image data to the destination apparatus if the result of the decision by the decision part 34 is a mismatch and executes the transmission of the image data only if the result of the decision by the decision part 34 is a match.

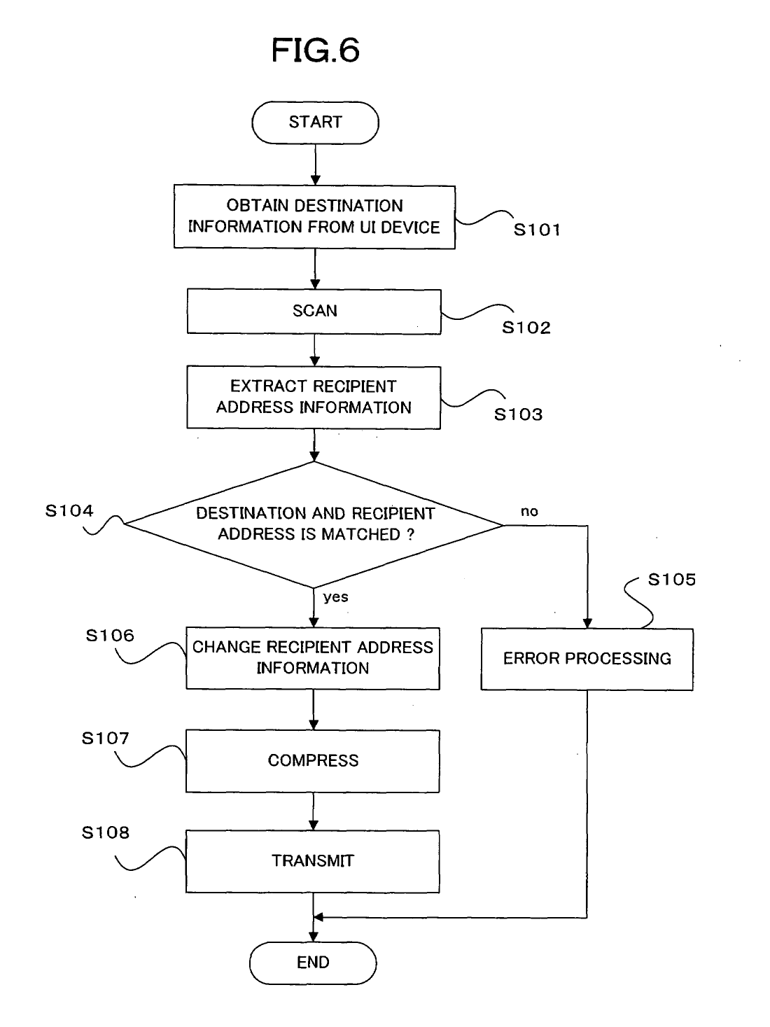

Next, the operation of the image transmitting and receiving apparatus 10 of the present exemplary embodiment is described in detail with reference to a flowchart of FIG. 6

First, the image transmitting and receiving apparatus 10 obtains destination information, that is, the fax number of the destination apparatus via the UI device 35 (S101). When a command to transmit is issued, the image reading part 31 obtains image data by scanning the facsimile paper set to be faxed (S102). The image data read by the image reading part 31 is stored into the page memory 38, after subjected to necessary image processing such as binarizing by the image processing part 32. Then, the recipient address information extracting part 33 detects the recipient address information included in the image data after processed by image processing and extracts the recipient address information by decoding (S103).

Next, the decision part 34 decides whether the fax number of the destination specified via the UI apparatus 35 matches the recipient address information extracted from the recipient address information extracting part 33 (S104). If the result of the decision made at this step S104 is a mismatch, the fax number of the destination entered via the UI device 35 is judged as an erroneous input and error processing is performed (S105). In particular, an indication of probably erroneous input is presented to the user via the UI device 35 or the like and transmission by the transmitting part 40 is disabled.

If the result of the decision made at S104 is a match, the recipient address information changing part 37 changes the image of the recipient address information included in the image data, stored in the page memory 38, to the image of the apparatus' own address information stored in the memory 36 (S106), using the coordinates information indicated from the recipient address information extracting part 33.

Then, after the image data in the page memory 38 is compressed by the data compressing part 39 (S107), the image data is transmitted by the transmitting part 40 to the specified destination apparatus (S108).

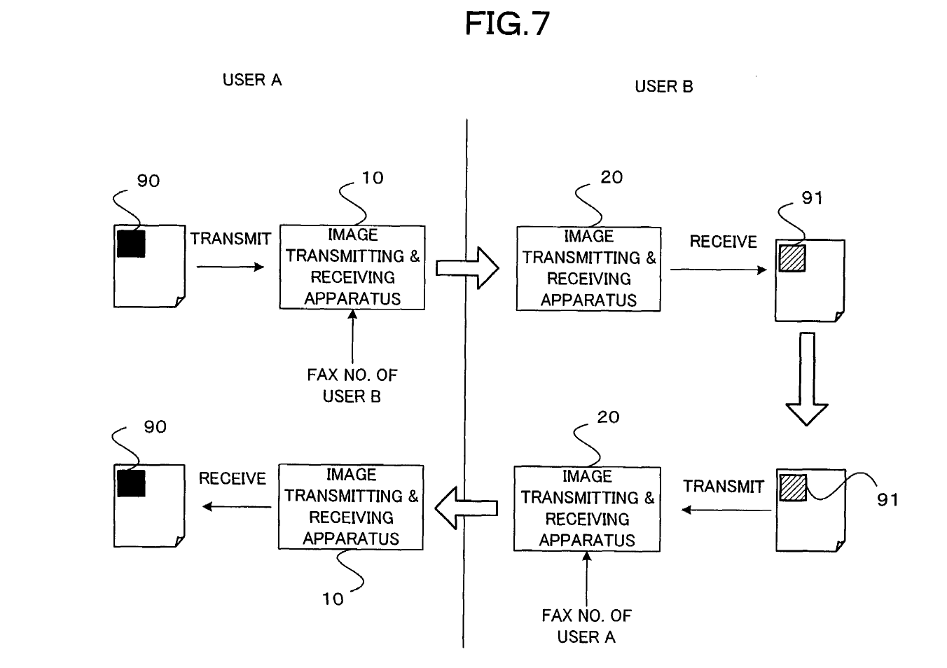

Next, the operation of the image transmitting and receiving apparatus 10 of the present exemplary embodiment is described with reference to FIG. 7.

This example shown in FIG. 7 illustrates a scenario where a form paper is faxed from user A to user B and user B fills in some information on the received form paper and sends back the form paper to user A.

First, at the image transmitting and receiving apparatus 10 of user A, a form paper to be faxed, imprinted with a two-dimensional code 90 in which the fax number of user B has been encoded, is set, and the fax number of user B is entered. Here, there is a match between the recipient address information of the form paper to be faxed and the entered fax number. Then, the image transmitting and receiving apparatus 10 changes the two-dimensional code 90 corresponding to the fax number of user B to a two-dimensional code 91 corresponding to the apparatus' own fax number of user A and then executes the transmission of the image data.

Consequently, at the image transmitting and receiving apparatus 20 of user B, the form paper imprinted with the two-dimensional code 91 of the fax number of user A is printed. After user B fills in some information on this form paper, the form paper is set at the image transmitting and receiving apparatus 20 and user B enters the fax number of user A. At this time, in the image transmitting and receiving apparatus 20, it is decided whether the entered fax number matches the recipient address information represented by the two-dimensional code 91 imprinted on the form paper that has been set. There is also a match between the recipient address information of the form paper to be faxed and the entered fax number. Then, the image transmitting and receiving apparatus 20 changes the two-dimensional code 90 corresponding to the fax number of user A to the two-dimensional code 91 corresponding to the apparatus' own fax number of user B and then executes the transmission of the image data.

Consequently, at the image transmitting and receiving apparatus 10 of user A, the form paper imprinted with the two-dimensional code 90 of the fax number of user B is printed. Thus, it is also possible to send back again this form paper from the image transmitting and receiving apparatus 10 of user A to the image transmitting and receiving apparatus 20 of user B.

### Second Exemplary Embodiment

Next, image transmitting and receiving apparatus of a second exemplary embodiment of the present invention is described.

The foregoing first exemplary embodiment is adapted such that, when the apparatus transmits a facsimile paper to be faxed, it changes the recipient address information to the apparatus' own address information for realizing the misdirected transmission preventing function and transmits the facsimile paper to the specified destination. Thus, the destination apparatus that receives the faxed facsimile paper can use the misdirected transmission preventing function when sending back the same facsimile paper to the sender apparatus.

However, as various forms may be faxed, it may be necessary to forward a form paper to another apparatus, not only sending back it to the sender apparatus. For example, the sender of an order form and the section that accepts the order may be at different locations. The sender of questionnaires and the section that collects the questionnaires may be at different locations.

Thus, the image transmitting and receiving apparatus of the second exemplary embodiment of the present invention is adapted such that, when the apparatus transmits a facsimile paper to be faxed, it does not change the image of the recipient address information included in the image data to be transmitted to the apparatus' own address information; instead, the destination apparatus changes the recipient information to the recipient address information of the next-hop destination apparatus.

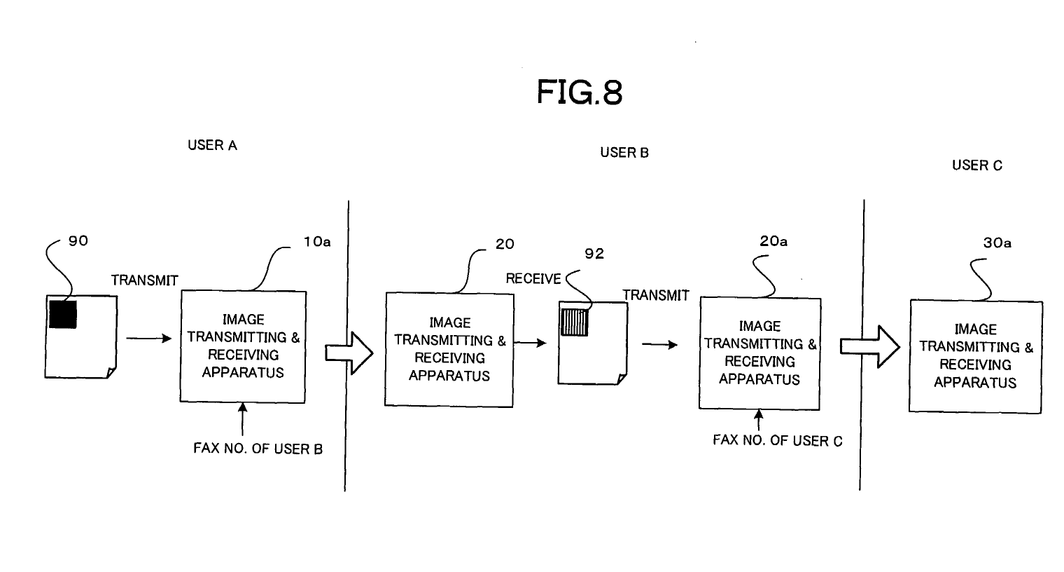

Then, the operation of image transmitting and receiving apparatuses 10a, 20a, 30a of the second exemplary embodiment of the present invention is described with reference to FIG. 8.

The image transmitting and receiving apparatuses 10a, 20a, 30a of the present exemplary embodiment differs from the apparatuses of the foregoing exemplary embodiment only in that the recipient address information in the image data to be transmitted is changed to the recipient address information of the next-hop destination apparatus, not the sender apparatus' own address information. Other details of the configuration are the same as the configuration shown in FIG. 5 and, therefore, a description thereof is not repeated here.

The example shown in FIG. 8 illustrates a scenario where user A faxes a facsimile paper to user B and user B who received the faxed facsimile paper fills in some information on the page and forwards the same facsimile paper to user C.

First, at the image transmitting and receiving apparatus 10a of user A, a form paper to be faxed, imprinted with the two-dimensional code 90 in which the fax number of user B has been encoded, is set, and the fax number of user B is entered. Here, there is a match between the recipient address information of the form paper to be faxed and the entered fax number. Then, the image transmitting and receiving apparatus 10a changes the two-dimensional code 90 corresponding to the fax number of user B to a two-dimensional code 92 corresponding to the fax number of user C which is the next-hop destination and executes the transmission of the image data.

Consequently, at the image transmitting and receiving apparatus 20a of user B, the form paper imprinted with the two-dimensional code 92 of the fax number of user C is printed. After user B fills in some information on this form paper, the form paper is set at the image transmitting and receiving apparatus 20a and user B enters the fax number of user C. At this time, in the image transmitting and receiving apparatus 20a, it is decided whether the entered fax number matches the recipient address information represented by the two-dimensional code 91 imprinted on the form paper that has been set. There is also a match between the recipient address information of the facsimile paper to be faxed and the entered fax number. Thus, the image transmitting and receiving apparatus 20a executes the transmission of the image data to the image transmitting and receiving apparatus 30a of user C.

### Modification Example

The foregoing description of the first and second exemplary embodiments assumes that recipient address information in which the fax number of the destination apparatus has been encoded beforehand is imprinted on a form paper to be transmitted. However, at an initial stage, even when the recipient address information is not imprinted on the form paper to be transmitted, the present invention can be applied in a similar manner.

As noted above, it is considered that the misdirected transmission preventing function is more required when a form paper filled with some information is transmitted than when a blank form paper is transmitted. Thus, it may be arranged that the misdirected transmission preventing function is used only when a form paper filled with information is sent back to the sender or forwarded to another apparatus, but is not used when a blank form paper is transmitted.

Specifically, in the system shown in FIG. 7, user A will transmit a form paper which is not imprinted with the recipient address information and, in the image transmitting and receiving apparatus 10, the decision as to whether the recipient address information matches the entered fax number is not performed. At the image transmitting and receiving apparatus 10, the two-dimensional code 91 in which the fax number of user A has been encoded is imprinted on the form paper which has been read and the form paper is transmitted to the image transmitting and receiving apparatus 20.

In this case, in the image transmitting and receiving apparatus 10 shown in FIG. 5, the recipient address information extracting part 33 and the decision part 34 become unnecessary and the recipient address information changing part 37 functions as a recipient address information imprinting unit that imprints the apparatus' own address information or the address information of the next-hop destination apparatus on the facsimile paper to be faxed.

While the recipient address information is changed at the transmitting side apparatus that transmit image data in the foregoing first and second exemplary embodiments, the recipient address information may remain erased after confirming that there is a match between the recipient address information and specified destination address information. Doing so allows the image receiving side apparatus to send back or forward the facsimile paper without an error posed by the misdirected transmission preventing function. However, in this case, the image receiving side apparatus cannot utilize the misdirected transmission preventing function.

In this case, an erasure part that erases the recipient address information included in the image data to be transmitted may be provided instead of the recipient address information changing part 37.

While the foregoing first and second exemplary embodiments are arranged such that the image transmitting and receiving apparatus that transmits image data changes the recipient address information, the image receiving side apparatus that receives image data may change, imprint or erase the recipient address information.

In this case, an image receiving apparatus including a receiving part that receives image data transmitted and an image forming part that forms an image such as a printed image based on the received image data may be provided with the recipient address information changing part 37, as shown in FIG. 5, and an imprinting part or an erasure part.

Furthermore, the present invention also involves a configuration of an image transmitting apparatus or an image receiving apparatus that includes a processing part that performs some processing on the recipient address information included in the image data read by th image reading part or the image data received by the receiving part, not only changing, imprinting, or erasing the recipient address information.

### Third Exemplary Embodiment

Next, an image transmitting and receiving apparatus of a third exemplary embodiment of the present invention is described.

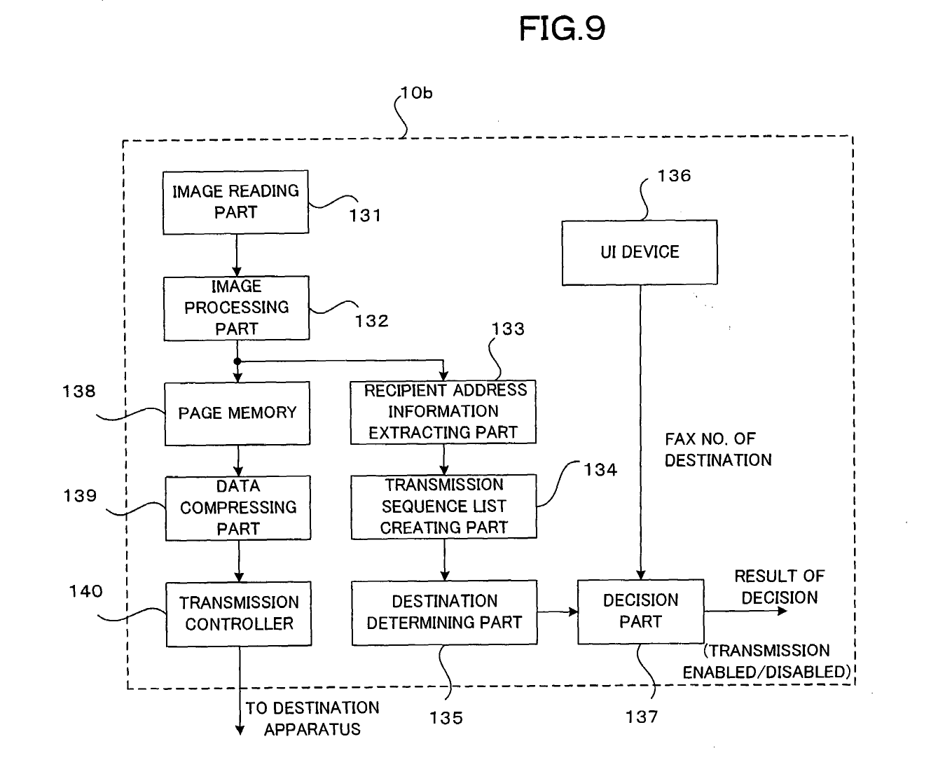

FIG. 9 is a block diagram showing an organization of functions of an image transmitting and receiving apparatus lob, which are realized by executing the above-mentioned program for transmitting and receiving images.

As shown in FIG. 9, the image transmitting and receiving apparatus lob of the present exemplary embodiment includes an image reading part 131, an image processing part 132, a recipient address information extracting part 133, a transmission sequence list creating part 134, a destination determining part 135, a user interface (UI) device 136, a decision part 137, a page memory 138, a data compressing part 139, an a transmission controller 140.

The image reading part 131 reads image data of a facsimile paper to be faxed. The image processing part 132 performs image processing such as filtering, binarizing, etc. on image data read by the image reading part 131. The page memory 138 stores image data processed by the image processing part 132 as the image data to be transmitted to a destination apparatus.

The user interface (UI) device 136 functions as an input destination specifying unit by entering recipient address information such as the fax number of the destination.

An image of recipient address information including encoded multiple fax numbers (recipient addresses) is imprinted on a facsimile paper to be faxed, which is used in the image transmitting and receiving system of the present exemplary embodiment. In the present exemplary embodiment, it is assumed that a two-dimensional code such as QR code is used as the image of encoded recipient address information.

The recipient address information extracting part 133 detects the image of recipient address information included in the image data processed by the image processing part 132 and extracts multiple fax numbers by decoding.

The transmission sequence list creating part 134 creates a transmission sequence list by rearranging the multiple fax numbers extracted by the recipient address information extracting part 133 in order of transmission.

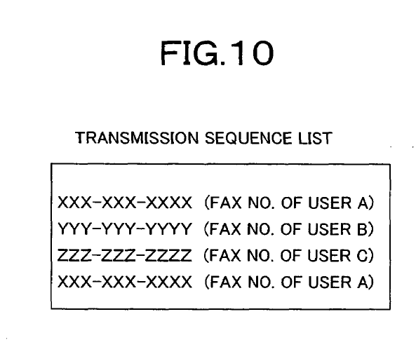

An example of a transmission sequence list thus created is shown in FIG. 10.

In the example shown in FIG. 10, the transmission sequence list is made up of four fax numbers arranged in order of transmission. The example shown in FIG. 10 is an example of the transmission sequence list which is used in an instance where the facsimile paper to be faxed is forwarded in order from user A→user B→user C→user A.

If it is predefined that the last address entry in the transmission sequence list corresponds to the first address entry in the next transmission sequence, the last address entry “XXX-XXX-XXXX (the fax number of user A) in the transmission sequence list shown in FIG. 10 is unnecessary.

Although the transmission sequence list creating part 134 rearranges multiple recipient addresses in order of transmission in the above description, the multiple recipient addresses may be arranged in order of transmission beforehand within the image of encoded recipient address information or the recipient addresses and transmission order information may be included separately.

If the multiple recipient addresses are arranged in order of transmission beforehand within the image of encoded recipient address information, the transmission sequence list creating part 134 does not need to rearrange the multiple recipient addresses extracted by the recipient address information extracting part 133 in order of transmission.

In this case, the transmission sequence list creating part 134 only lists the multiple recipient addresses in the order in which they are extracted by the recipient address information extracting part 133 for arrangement in order of transmission.

If the transmission order information is included in the image of recipient address information, the transmission sequence list creating part 134 rearranges the multiple recipient addresses extracted by the recipient address information extracting part 133 in order of transmission by using this transmission order information.

The destination determining part 135 determines the recipient address of a next-hop destination from the transmission sequence list created by the transmission sequence list creating part 134 and the apparatus' own fax number.

In particular, if the apparatus' own fax number is in the N-th position in the transmission sequence list, the destination determining part 135 determines the fax number in the (N+1)-th position in the transmission sequence list as the recipient address of the destination.

In other words, the destination determining part 135 determines the fax number next to the apparatus' own fax number in the order of transmission within the transmission sequence list created by the transmission sequence list creating part 134 as the recipient address of the next-hop destination.

The decision part 137 decides whether the fax number of destination entered via the UI device 136 matches the recipient address determined by the destination determining part 135.

The data compressing part 139 compresses image data stored in the page memory 38.

The transmission controller 140 transmits the data compressed by the data compressing part 139 to the specified destination apparatus, depending on the result of the decision made by the decision part 137. In particular, the transmission controller 140 disables transmitting the image data to the destination apparatus if the result of the decision by the decision part 34 is a mismatch and executes the transmission of the image data only if the result of the decision by the decision part 34 is a match.

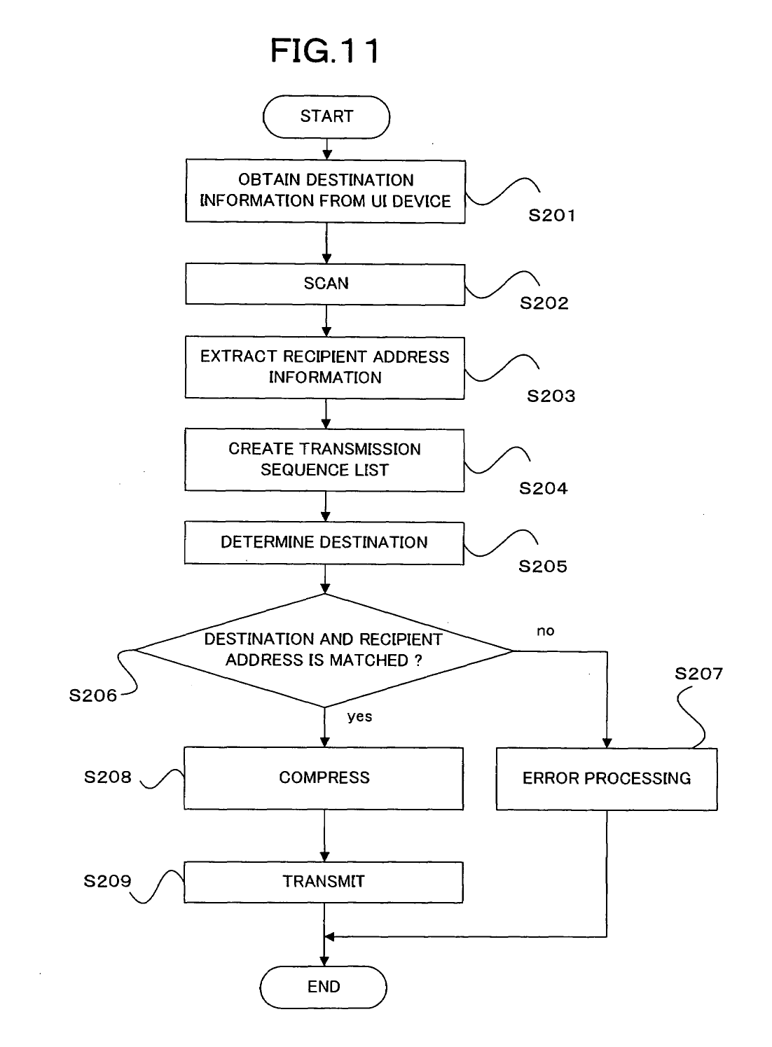

Next, the operation of the image transmitting and receiving apparatus 10 of the present exemplary embodiment is described in detail with reference to a flowchart of FIG. 11.

First, the image transmitting and receiving apparatus 10b obtains destination information, that is, the fax number of the destination apparatus via the UI device 136 (S201). When a command to transmit is issued, the image reading part 131 obtains image data by scanning the facsimile paper set to be faxed (S202) The image data read by the image reading part 131 is stored into the page memory 138, after being subjected to necessary image processing such as binarizing by the image processing part 132. Then, the recipient address information extracting part 133 detects the recipient address information included in the image data after processed by image processing and extracts the recipient address information by decoding (S203).

Next, the transmission sequence list creating part 134 creates a transmission sequence list by rearranging multiple recipient addresses extracted by the recipient address information extracting part 133 in order of transmission (S204). Then, the destination determining part 135 determines the recipient address of the destination from the transmission sequence list created by the transmission sequence list creating part 134 and the apparatus' own fax number (S205).

Next, the decision part 134 decides whether the fax number of destination specified via the UI device 136 matches the recipient address information extracted by the recipient address information extracting part 133 (S206). If the result of the decision made at this step S206 is a mismatch, the fax number of the destination entered via the UI device 136 is judged as an erroneous input and error processing is performed (S207). In particular, an indication of probably erroneous input is presented to the user via the UI device 136 or the like and the transmission controller 140 disables transmission.

If the result of the decision made at S206 is a match, the image data from the page memory 38 is compressed by the compressing part 139 (S208) and then transmitted to the specified destination apparatus by the transmission controller 140 (S209).

The compressing part 139 may always compress image data, regardless of the result of the decision made at S206. In such case, after the compressed data is stored into the memory, the transmission controller 140 transmits the compressed data to the specified destination apparatus only when the result of the decision is a match.

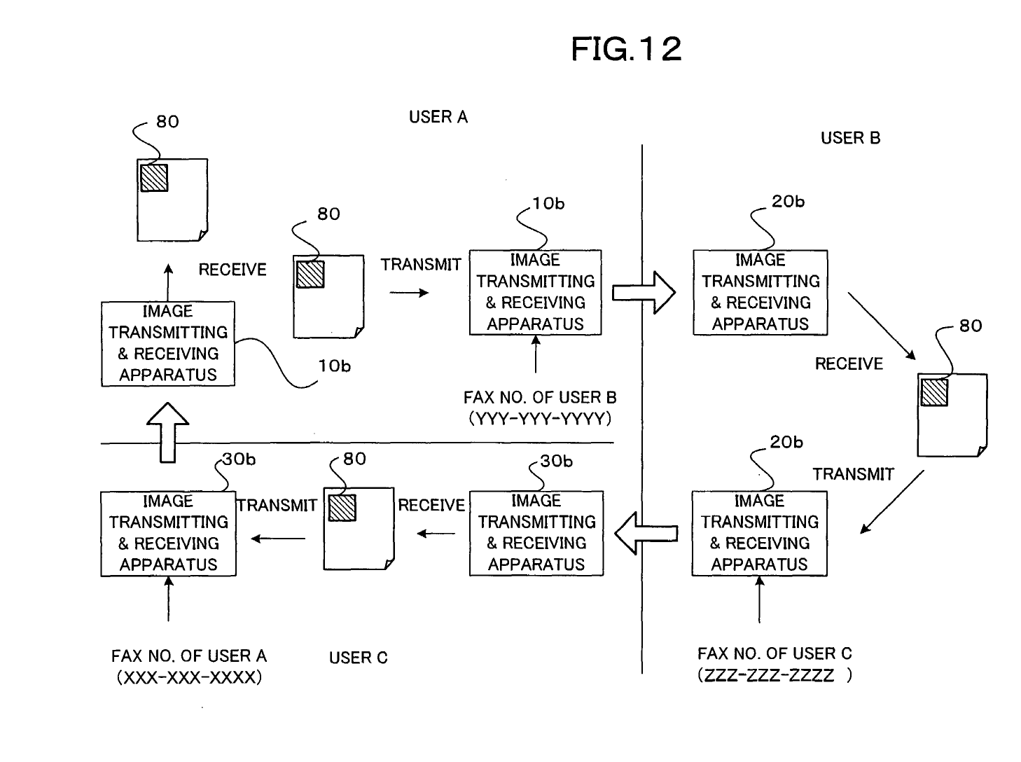

Next, the operation of the image transmitting and receiving system of the present exemplary embodiment is described with reference to FIG. 12.

The example shown in FIG. 12 illustrates a scenario where the same facsimile paper to be faxed is circulated in order from user A→user B→user C→user A.

It is assumed that a two-dimensional code 80 as an image of recipient address information is imprinted on the facsimile paper to be circulated by facsimile. It is also assumed that, in the two-dimensional code 40, four recipient addresses are encoded in the order of transmission, as shown in FIG. 10.

First, at the image transmitting and receiving apparatus 10b of user A, the facsimile paper to be faxed, imprinted with the two-dimensional code 80, is set, and the fax number “YYY-YYY-YYYY” of user B is entered. At the image transmitting and receiving apparatus lob, the recipient address of the next-hop destination is decided to be “YYY-YYY-YYYY” from the apparatus' own fax number (XXX-XXX-XXX) and the transmission sequence list shown in FIG. 10. Thus, the decision part 137 decides that the entered fax number of destination matches the fax number of the next-hop destination. Thus, the transmission controller 140 transmits the facsimile paper set to be faxed to the image transmitting and receiving apparatus 20b of user B.

Next, at the image transmitting and receiving apparatus 20b of user B, the faxed facsimile paper imprinted with the two-dimensional code 80 is received. After user B puts a checkmark or the like on the faxed facsimile paper to indicate that the user has received the facsimile paper, user B sets the same facsimile paper at the image transmitting and receiving apparatus 20b and enters the fax number of user C. At this time, in the image transmitting and receiving apparatus 20b, it is decided whether the entered fax number matches the fax number of the next-hop destination determined from the two-dimensional code 80 imprinted on the set facsimile paper. There is also a match between the entered fax number and the fax number of the next-hop destination determined from the two-dimensional code 80 imprinted on the set facsimile paper, as both are the fax number “ZZZ-ZZZ-ZZZZ” of user C. Thus, the image transmitting and receiving apparatus 20b transmits the facsimile paper to be faxed, imprinted with the two-dimensional code 80, to the image transmitting and receiving apparatus 30b of user C.

Likewise, at the image transmitting and receiving apparatus 30b of user C, the faxed facsimile paper imprinted with the two-dimensional code 80 is received. After user C puts a checkmark or the like on the faxed facsimile paper to indicate that the user has received the facsimile paper, user C sets the same facsimile paper at the image transmitting and receiving apparatus 30b and enters the fax number of user A. Accordingly, there is a match between the entered fax number and the fax number of the next-hop destination determined from the two-dimensional code 80 imprinted on the set facsimile paper, as both are the fax number “XXX-XXX-XXXX” of user A. Thus, the image transmitting and receiving apparatus 30b transmits the facsimile paper to be faxed, imprinted with the two-dimensional code 80, to the image transmitting and receiving apparatus 10b of user A.

In this way, the facsimile paper initially faxed from user A is circulated to user B and user C and eventually forwarded to user A. At any of the image transmitting and receiving apparatuses 10b to 30b of user A, user B, and user C, transmission is disabled if a wrong fax number is entered; thus, the misdirected transmission preventing function works effectively.

In the above description of the present exemplary embodiment, the decision part 137 decides whether the fax number of destination entered via the UI device 136 is identical to the recipient address determined by the destination determining part 135. However, the decision part 137 may allow transmission if the fax number of destination entered via the UI device 136 matches any one of the multiple recipient addresses extracted by the recipient address information extracting part 133. In this case, the transmission controller 140 performs control to transmit the image data to the specified destination if the decision part 137 decides that the specified fax number of destination matches any one of the multiple fax numbers extracted; and it performs control to disable the transmission of the image data to the specified destination if the specified fax number does not match any of the multiple fax numbers extracted.

As above, if the decision part 137 is adapted to decide whether the transmission is enabled or disabled without regard to the order of transmission, the misdirected transmission preventing function can be used in an instance where transmission to any of multiple destinations which have been preset takes place, not occurring in predetermined order of transmission. Furthermore, the misdirected transmission preventing function can be used even in operation of broadcast transmission in which the same facsimile paper is faxed from one sender to multiple recipients and group transmission in which multiple destinations are registered beforehand as one group.

### Modification Example

While the description of the foregoing exemplary embodiments assumes that all image transmitting and receiving apparatuses are provided with both the image transmitting function and the image receiving function, the present invention is also applicable in a similar manner to an image transmitting apparatus provided with only the image transmitting function or an image receiving apparatus provided with only the image receiving function. In this case, the image receiving apparatus is provided with at least the receiving part that receives image data transmitted and the image forming part that forms an image such as a printed image based on the received image data, which are not, however, shown in FIG. 5 and FIG. 9. At least one image transmitting apparatus and at least one image receiving apparatus can constitute an image transmitting and receiving system.

In the description of the foregoing exemplary embodiments, a two-dimensional code is used as the recipient address information; however, the present invention is not so limited. The present invention is applicable in a similar manner even when other data such as a one-dimensional code typified by bar code is used as the recipient address information.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An image transmitting apparatus comprising:
an image reading unit that reads image data;
a decision unit that decides whether recipient address information included in the image data read by the image reading unit matches recipient address information specified as a destination;
a processing unit that processes the recipient address information included in the image data read by the image reading unit; and
a transmitting unit that transmits the image data in which the recipient address information has been processed by the processing unit to the specified destination, depending on a result of the decision made by the decision unit.

2. The image transmitting apparatus according to claim 1, wherein the processing unit is an imprinting unit that imprints the recipient address information of a next-hop destination apparatus to which a destination apparatus is to transmit on the image data read by the image reading unit.

3. The image transmitting apparatus according to claim 1, wherein the processing unit is an imprinting unit that imprints the apparatus' own address information which is stored in a memory on the image data read by the image reading unit.

4. The image transmitting apparatus according to claim 1, wherein the processing unit is a change making unit that changes the recipient address information included in the image data read by the image reading unit to the recipient address information of a next-hop destination apparatus to which a destination apparatus is to transmit.

5. The image transmitting apparatus according to claim 1, wherein the processing unit is a change making unit that changes the recipient address information included in the image data read by the image reading unit to the apparatus' own address information which is stored in the memory.

6. The image transmitting apparatus according to claim 1, wherein the processing unit is an erasure unit that erases the recipient address information included in the image data read by the image reading unit.

7. An image transmitting and receiving apparatus, comprising:
an image reading unit that reads image data;
a decision unit that decides whether recipient address information included in the image data read by the image reading unit matches recipient address information specified as a destination;
a processing unit that processes the recipient address information included in the image data read by the image reading unit;
a transmitting unit that transmits the image data in which the recipient address information has been processed by the processing unit to the specified destination, depending on a result of the decision made by the decision unit;
a receiving unit that receives image data transmitted; and
an image forming unit that forms an image based on the image data received by the receiving unit.

8. An image transmitting and receiving system comprising:
an image transmitting apparatus including an image reading unit that reads image data, a decision unit that decides whether recipient address information included in the image data read by the image reading unit matches recipient address information specified as a destination, a processing unit that processes the recipient address information included in the image data read by the image reading unit, and a transmitting unit that transmits the image data in which the recipient address information has been processed by the processing unit to the specified destination, depending on the result of the decision made by the decision unit; and
an image receiving apparatus including a receiving unit that receives image data transmitted from the image transmitting apparatus and an image forming unit that forms an image based on the image data received by the receiving unit.

9. An image receiving apparatus, comprising:
a receiving unit that receives image data transmitted;
a processing unit that processes recipient address information included in the image data received by the receiving unit; and
an image forming unit that forms an image based on the image data in which the recipient address information has been processed by the processing unit.

10. The image receiving apparatus according to claim 9, wherein the processing unit is an imprinting unit that imprints the recipient address information of an apparatus from which the image data has been transmitted on the image data received by the receiving unit.

11. The image receiving apparatus according to claim 9, wherein the processing unit is a change making unit that the recipient address information included in the image data received by the receiving unit to the recipient address information of an apparatus from which the image data has been transmitted.

12. The image receiving apparatus according to claim 9, wherein the processing unit is an erasure unit that erases the recipient address information included in the image data received by the receiving unit.

13. An image transmitting and receiving apparatus, comprising:
an image reading unit that reads image data;
a transmitting unit that transmits the image data read by the image reading unit to a specified destination;
a receiving unit that receives image data transmitted;
a processing unit that processes recipient address information included in the image data received by the receiving unit; and
an image forming unit that forms an image based on the image data in which the recipient address information has been processed by the processing unit.

14. An image transmitting and receiving system, comprising:
an image transmitting apparatus including an image reading unit that reads image data and a transmitting unit that transmits the image data read by the image reading unit to a specified destination; and
an image receiving apparatus including a receiving unit that receives the image data transmitted from the image transmitting unit, a processing unit that processes recipient address information included in the image data received by the receiving unit, and an image forming unit that forms an image based on the image data in which the recipient address information has been processed by the processing unit.

15. An image transmitting apparatus, comprising:
an image reading unit that reads image data;
a recipient address information extracting unit that detects an image of recipient address information included in the image data read by the image reading unit and extracts a plurality of recipient addresses;
a destination specifying unit that allows the user to specify the destination to which the image data is to be transmitted;
a decision unit that decides whether the recipient address information of the destination specified by the destination specifying unit matches any one of the plurality of recipient addresses extracted by the recipient address information extracting unit; and
a transmission controller that performs control to transmit the image data to the specified destination, if the decision unit decides that the specified destination matches any one of the plurality of recipient addresses.

16. An image transmitting apparatus comprising:
an image reading unit that reads image data;
a recipient address information extracting unit that detects an image of recipient address information included in the image data read by the image reading unit and extracts a plurality of recipient addresses;
a destination specifying unit that allows the user to specify a destination to which the image data is to be transmitted;
a decision unit that decides whether the recipient address information of the destination specified by the destination specifying unit matches any one of the plurality of recipient addresses extracted by the recipient address information extracting unit; and
a transmission controller that performs control to disable the transmission of the image data to the specified destination, if the decision unit decides that the specified destination does not match any of the plurality of recipient addresses.

17. An image transmitting and receiving apparatus, comprising:
an image reading unit that reads image data;
a recipient address information extracting unit that detects an image of recipient address information included in the image data read by the image reading unit and extracts a plurality of recipient addresses;
a destination specifying unit that allows the user to specify a destination to which the image data is to be transmitted;
a decision unit that decides whether the recipient address information of the destination specified by the destination specifying unit matches any one of the plurality of recipient addresses extracted by the recipient address information extracting unit;
a transmission controller that performs control to transmit the image data to the specified destination, if the decision unit decides that the specified destination matches any one of the plurality of recipient addresses;
a receiving unit that receives image data transmitted; and
an image forming unit that forms an image based on the image data received by the receiving unit.

18. An image transmitting and receiving system, comprising:
an image transmitting apparatus including an image reading unit that reads image data, a recipient address information extracting unit that detects an image of recipient address information included in the image data read by the image reading unit and extracts a plurality of recipient addresses, a destination specifying unit that allows the user to specify a destination to which the image data is to be transmitted, a decision unit that decides whether the recipient address information of the destination specified by the destination specifying unit matches any one of the plurality of recipient addresses extracted by the recipient address information extracting unit, and a transmission controller that performs control to transmit the image data to the specified destination, if the decision unit decides that the specified destination matches any one of the plurality of recipient addresses; and
an image receiving apparatus including a receiving unit that receives image data transmitted and an image forming unit that forms an image based on the image data received by the receiving unit.

19. An image transmitting apparatus, comprising:
an image reading unit that reads image data;
a recipient address information extracting unit that detects an image of recipient address information included in image data that is going to be transmitted and extracts a plurality of recipient addresses;
a destination specifying unit that allows the user to specify a destination to which the image data is to be transmitted;
a transmission sequence list creating unit that creates a transmission sequence list by rearranging the plurality of recipient addresses extracted by the recipient address information extracting unit in order of transmission;
a destination determining unit that determines recipient address information of a next-hop destination from the transmission sequence list created by the transmission sequence list creating unit and the apparatus' own address information;
a decision unit that decides whether the recipient address information of the destination specified by the destination specifying unit matches the recipient address information of the destination determined by the destination determining unit; and
a transmission controller that performs control to transmit the image data to the specified destination, if the decision unit decides that the specified destination matches the recipient address information of the destination determined by the destination determining unit.

20. An image transmitting apparatus, comprising:
an image reading unit that reads image data;
a recipient address information extracting unit that detects an image of recipient address information included in image data that is going to be transmitted and extracts a plurality of recipient addresses;
a destination specifying unit that allows the user to specify a destination to which the image data is to be transmitted;
a transmission sequence list creating unit that creates a transmission sequence list by rearranging the plurality of recipient addresses extracted by the recipient address information extracting unit in order of transmission;
a destination determining unit that determines recipient address information of a next-hop destination from the transmission sequence list created by the transmission sequence list creating unit and the apparatus' own address information;
a decision unit that decides whether the recipient address information of the destination specified by the destination specifying unit matches the recipient address information of the destination determined by the destination determining unit; and
a transmission controller that performs control to disable the transmission of the image data to the specified destination, if the decision unit decides that the specified destination does not match the recipient address information of the destination determined by the destination determining unit.

21. The image transmitting apparatus according to claim 19, wherein the transmission sequence list creating unit rearranges the plurality of recipient addresses extracted by the recipient address information extracting unit in order of transmission by using transmission order information included in the image of recipient address information.

22. The image transmitting apparatus according to claim 19,
wherein the plurality of recipient addresses included in the image of recipient address information are arranged in order of transmission, and
the transmission sequence list creating unit lists the plurality of recipient addresses in the order in which the recipient addresses are extracted by the recipient address information extracting unit for arrangement in order of transmission.

23. The image transmitting apparatus according to claim 19, wherein the destination determining unit determines a recipient address next to the apparatus' own address in the order of transmission in the transmission sequence list created by the transmission sequence list creating unit as the recipient address information of the next-hop destination.

24. An image transmitting and receiving apparatus, comprising:
an image reading unit that reads image data;
a recipient address information extracting unit that detects an image of recipient address information included in image data that is going to be transmitted and extracts a plurality of recipient addresses;
a destination specifying unit that allows the user to specify a destination to which the image data is to be transmitted;
a transmission sequence list creating unit that creates a transmission sequence list by rearranging the plurality of recipient addresses extracted by the recipient address information extracting unit in order of transmission;
a destination determining unit that determines recipient address information of a next-hop destination from the transmission sequence list created by the transmission sequence list creating unit and the apparatus' own address information;
a decision unit that decides whether the recipient address information of the destination specified by the destination specifying unit matches the recipient address information of the destination determined by the destination determining unit;
a transmission controller that performs control to transmit the image data to the specified destination, if the decision unit decides that the specified destination matches the recipient address information of the destination determined by the destination determining unit;
a receiving unit that receives image data transmitted; and
an image forming unit that forms an image based on the image data received by the image receiving unit.

25. An image transmitting and receiving system, comprising:
an image transmitting apparatus including an image reading unit that reads image data, a recipient address information extracting unit that detects an image of recipient address information included in image data that is going to be transmitted and extracts a plurality of recipient addresses, a destination specifying unit that allows the user to specify a destination to which the image data is to be transmitted, a transmission sequence list creating unit that creates a transmission sequence list by rearranging the plurality of recipient addresses extracted by the recipient address information extracting unit in order of transmission, a destination determining unit that determines recipient address information of a next-hop destination from the transmission sequence list created by the transmission sequence list creating unit and the apparatus' own address information, a decision unit that decides whether the recipient address information of the destination specified by the destination specifying unit matches the recipient address information of the destination determined by the destination determining unit, and a transmission controller that performs control to transmit the image data to the specified destination, if the decision unit decides that the specified destination matches the recipient address information of the destination determined by the destination determining unit; and
an image receiving apparatus including a receiving unit that receives image data transmitted and an image forming unit that forms an image based on the image data received by the image receiving unit.
